(19) United States
(12) Patent Application Publication
(10) Pub. No.: US 2025/0314128 A1
(43) Pub. Date: Oct. 9, 2025

(54) A ROLLER BLIND SYSTEM WITH INTEGRATED PHOTOVOLTAICS

(71) Applicant: Zinniatek Limited, Auckland (NZ)

(72) Inventor: Andrew Leo Haynes, Auckland (NZ)

(73) Assignee: Zinniatek Limited, Auckland (NZ)

(21) Appl. No.: 18/865,136

(22) PCT Filed: Jun. 1, 2023
(86) PCT No.: PCT/IB2023/055620

§ 371 Date: Nov. 12, 2024

(30) Foreign Application Priority Data
Jun. 1, 2022 (NZ) 788881

(51) Int. Cl. E06B 9/68; E06B 9/24; E06B 9/40; E06B 9/42; F21V 3/00; H02S 10/20; H02S 20/26; H02S 30/20

(52) U.S. Cl. CPC E06B 9/68; E06B 9/42; F21V 3/00; H02S 10/20; H02S 20/26; H02S 30/20; E06B 2009/2452; E06B 2009/247; E06B 2009/2476; E06B 2009/405; E06B 2009/6827

(57) ABSTRACT

This invention relates to a roller blind system. The roller blind system comprising of a roller blind, the roller blind comprising of a photovoltaic film configured to, in-use, face towards an external face of a building envelope, and an energy storage system receivable of power generated from the photovoltaic film. A motor is connectable via a drive system for winding of the roller blind, the roller blind to be wound to an advanced or retracted position, and a controller is configured to operate at least the motor for windingly advancing or retracting the roller blind to a desired extension position.

### TECHNICAL FIELD

This disclosure relates to a roller blind system with integrated photovoltaics, and particularly to a roller blind system comprising of a photovoltaic system. The roller blind system includes functionalities capable of which utilise power generated by the photovoltaic system.

### BACKGROUND ART

Roller blinds or screens are used for a variety of purposes, typically to control the amount of light entering a room or space from a window over which the blind is to be provided as a cover or screen. Roller blinds are used in number of applications, including commercial and industrial applications. For example, roller blinds are also used in agricultural applications to provide shade or shielding of sunlight entering glass houses or polyhouses or other such enclosures (whether for controlling light/energy entering a housing, for growing of plants or even for sheltering of animals). Offices and homes or other commercial buildings also often use roller blinds to help control glare or sunlight entering the building.

Many of these roller blinds are operated manually by a pull cord attached to a roller or other gear. Similarly, many roller blinds are operated via motors with their associated gears or drive mechanisms to actuate a blind which is wound up into a roll, to be unwound or unfurled to a desired extension position. A wide variety of control systems are provided to allow a user to determine their desired length of blind extension or retraction—for example, retracted and extended positions can be controlled, and a blind may operate on a scheduled basis or manual basis or via other user-determined controls.

Some motorised roller blinds operate via electrical connection to a power source, such as a mains or building power source, or may be via a battery. Some roller blinds may also operate by the use of a separate solar cell or photovoltaic system, typically located remotely, which is used to generate power, store that power and then use that power on demand to advance or retract the roller blind as desired.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### SUMMARY

It is an object of this disclosure to provide a roller blind system which goes at least some way towards overcoming one or more of the above-mentioned problems or difficulties, or to provide the industry/public with a useful choice.

It can be an alternative object of this disclosure to provide for a roller blind system which provides for a roller blind system that is capable of generating its own power, advantageously where at least a portion of the roller blind comprises a photovoltaic film that, in-use, faces towards an external face of a building envelope, or alternatively that is integrated as part of the roller itself and is operable electrically independently (i.e. is not remotely powered, either by a remote photovoltaic power system or connected to mains power or a building power supply), and which may go at least some way towards overcoming one or more of the above mentioned problems or difficulties, or to provide the industry/public with a useful choice.

It can be an alternative object of this disclosure to provide for a roller blind system comprising of a photovoltaic film, at least a portion of the photovoltaic film remaining exposed by extending at least a portion of the roller blind from a fully retracted position, or in a fully wound up or rolled up position, such that such a portion of photovoltaic film remaining exposed is substantially sufficient to enable a minimum operation of the roller blind system, or provide for a minimum power requirement for minimum operation of the roller blind system.

It can be an alternative object of this disclosure to provide for a roller blind system comprising of a photovoltaic film capable of generating power, where generated power is employed for operation of a light (for illumination of a room or space in which the roller blind system is installed) integrated into the roller blind system.

In accordance with at least one of the embodiments disclosed herein, in a first aspect there is provided a roller blind system, the roller blind system comprising: a roller blind, the roller blind comprising of a photovoltaic film configured to, in-use, face towards an external face of a building envelope or a source of light, an energy storage system receivable of power generated from the photovoltaic film, a motor connectable via a drive system for winding of the roller blind, the roller blind to be wound to, or between, an advanced or retracted positions, a controller configured to operate at least the motor for windingly advancing or retracting the roller blind to a desired extension position.

According to the first aspect, the following details are provided:

The photovoltaic film may be a substantially flexible film.

The roller blind and photovoltaic film may be attached or connected to each other.

The roller blind and photovoltaic film may be attached or connected to each other by lamination or may be laminated together.

The photovoltaic film may extend substantially across the width of the roller blind, either partially or substantially wholly, across the width. Alternatively, or in addition, the photovoltaic film may extend substantially along the length of the roller blind, either partially or substantially wholly, along the length.

An internal facing side of the photovoltaic film may comprise of a decorative or non-decorative ornamentation.

The decorative or non-decorative ornamentation may be a printed layer or a laminated layer or otherwise attached layer of material to the internal facing side of the photovoltaic film.

The internal facing side of the roller blind may comprise of a tinted or non-tinted or coloured layer.

The photovoltaic film may comprise of the decorative or non-decorative layer as a layer of the photovoltaic film or may comprise of a tinted or non-tinted or coloured layer as a layer of the photovoltaic film.

The energy storage system may comprise one or more batteries, optionally the energy storage system has sufficient capacity to store all of the energy generated by the photovoltaic film on a daily basis.

The system may be provided in a ready-to-go configuration with the energy storage system factory installed with at least a minimum charge of power for an initial operation or initial configuration on-site, or an immediate use capability.

The system may be provided for on-site installation in a pre-assembled or ready-to-go configuration.

The energy storage system may be provided in a disconnected condition, awaiting final installation on-site.

A charging port may be provided to enable or provide a charge of power to said on-board energy storage system, or alternatively the charging port may be provided to extract power from the energy storage system (for example in an emergency use situation or as a remote charging of device function).

The charging port may be a universal serial bus (USB) port.

The system may be electrically independent of a building wiring system, or may be electrically independent of a building's power supply, or may be electrically connected, or connectable, to a building power supply or building wiring system to enable one or more lights to operate if the energy storage system does not have sufficient charge.

The system may further comprise of a housing as a blind box or a pelmet-style covering (or enclosure) of the system.

The system may further comprise one or more lights.

The one or more lights may be provided to assist with illuminating a room or space within which said system is installed or is to be operational.

The one or more lights are provided about or within the housing.

The housing may comprise one or more apertures through which said light from the one or more lights may be projected or directed.

A diffuser may be provided across the face of the one or more lights or across the face of the one or more apertures to diffuse the light.

The controller may adjust the brightness or luminous flux (or lumens) to be emitted by the one or more lights.

The light provided by the one or more lights may be projected or directed across the room/space, or projected or directed in an upwards direction for example toward a ceiling.

A siding or face of the housing may comprise the one or more lights.

At least one of the one or more lights may be provided to project or direct light upwardly towards a ceiling of the room/space within which said system is to be installed or is to be operational.

At least one of the one or more lights may be provided on an interior facing side surface of the housing (i.e., interior room/space facing direction, for example to project or direct light across the interior room/space).

An interior facing side surface of the housing may be angled such that a top edge of the housing extends horizontally beyond a lower edge of the housing.

The system may comprise a sensor or sensors for measurement and/or detection of one or more room conditions.

The one or more room conditions may be one or more of: motion or activity within a room/space (for example, occupancy), light level within a room/space (for example, ambient flux levels within the room/space), external ambient light level, combinations of room/space and external light levels, temperature of a room/space, a timer schedule based upon a time-of-day or day of week, a manual signal input from a user, gestures from a user (such as macro or micro physical gestures from a user), voice or other audible sounds from a user (such as voice or audible sound activation or control or commands, directly or indirectly, via one or more devices capable of measuring or detecting such sounds).

The controller may operate to adjust one or more of the following:
the motor to adjust the roller blind or screen to a desired extension position based upon one or more of the room conditions, for example to reduce light levels within a room/space or reduce incoming external light (e.g., sunlight as the light source),
the light output level in response to ambient light conditions (e.g., light output may be ramped up or ramped down as needed, or to provide for a slow or soft start or slow or soft finish to turning the one or more lights on or off).

The controller may operate to adjust based upon a measured or detected room condition.

The room condition may be measured or sensed by one or more sensors integrated with the system or as part of the housing.

The room condition may be measured or sensed by one or more sensors provided remotely about a room/space, and providing a signal back to the controller (e.g., the remote sensor or sensors may communicate with the controller via a wired or wireless communication link).

A manual input from a user may be a signal sent to/received by a sensor or the controller, to manually provide a desired extension position of the roller blind.

A user may manually set or adjust, from a default setting, a preferred light level within a room or temperature of a room or based upon the amount of motion or level or activity within a room over a period of time, or may adjust a pre-determined timer schedule or other automatic adjustment based upon a measured or detected room/space condition. For example, a seasonal adjustment based upon seasonal light source levels may be used to adjust a set point or a pre-determined extension position of the roller blind comprising of the photovoltaic film to a pre-determined length portion.

A signal from a user for the manual setting or adjustment may be communicated via a data communication link or network protocol via a wired or wireless communication or network or combination thereof (examples include, but are not limited to: NFC, wi-fi, Bluetooth, LTE, Zigbee communication link or network protocol enabled systems).

A manual adjustment may be provided for via a control panel or switching on a housing or other associated controller of the system (for example may have an on/off switch).

The roller blind system may be provided as a single unit configured for fastening or fixing into position (for example, the system can be fastened or fixed into a position to cover (partially or substantially wholly) a window or other sunlight light transmitting medium, including but not limited to one or more of: glass, polymers, composite materials).

The system may be configured as a single module or a plurality of modules (optionally one or more of which may be directly or indirectly connected or connectable with one or more other modules) which can either be factory pre-assembled or assembled on site.

The system may be provided as a single module without the need for additional on-site assembly or other connections, or may be provided as a single completed unit in a ready-to-ship or ready-to-install configuration.

The system may be independent or independently operable of or from a building's power or electrical supply, optionally the system may be connected or connectable to a building's power or electrical supply as a back-up power supply.

The system may communicate with, or be provided in communication with, a building management system (BMS).

The system may be operable or controllable via a BMS.

The system, when in an in-use or installed configuration, the blind is wound in a configuration such that a portion of photovoltaic film remains exposed.

A portion of the roller blind comprising of the photovoltaic film may remain exposed to, in-use, face towards an external face of a building envelope, even when in a fully or completely retracted blind position, or in a fully wound-up or rolled-up position.

In-use, a pre-determined length portion of said roller blind comprising of the photovoltaic film, may be left exposed (for example, for generation of photovoltaic energy and/or capture by said energy storage system).

In-use, a pre-determined length portion of said roller blind comprising of the photovoltaic film, may be left advanced (or extended) from a fully or completely retracted position, or from a fully wound-up or rolled-up position (for example, for exposure of the photovoltaic film for generation of photovoltaic energy and/or capture by said energy storage system). Advantageously, optionally, the pre-determined length portion may be adjusted based upon seasonal or weather patterns to compensate for seasonal or weather pattern light source levels.

The system may be pre-programmed to, upon initial set up (such as an initial operation or initial activation), wind said roller blind or screen to a pre-determined extension length or position (for example, to an advanced or retracted position).

An in-use maximum retracted position of the roller blind may be provided for a pre-determined minimum extension length substantially sufficient to enable a minimum power generation or charge of power for use by the system (for example, to be retained by the energy storage system).

A portion of the roller blind, once installed or when in an in-use configuration, may remain exposed to provide for a trickle charge capability.

A minimum exposed surface area of the photovoltaic film left exposed may self-adjust based upon a minimum required trickle charge or minimum stored power requirement of the energy storage system. For example, the minimum exposed surface area of the photovoltaic film left exposed may self-adjust based upon seasonal changes to account for a minimum required trickle charge or minimum stored power requirement of the energy storage system.

The energy storage system may be a battery or other electrical energy storage device.

Data relating to one or more sensed room conditions may be provided to a building management system (BMS) or other control system.

A plurality of systems may be provided and two or more of these may substantially operate as to a retracted or advanced blind length or position (or length of extension) or to substantially match a blind position. For example, at least two or more systems may operate as to a communal or communally retracted or advanced blind length or position (or length of extension).

The photovoltaic film may cover substantially all or substantially a partial surface area of the roller blind (for example, to enable some light to pass the blind).

The photovoltaic film may be provided as a pattern across the roller blind (for example, as a series of stripes, whether at an angle or substantially vertical or substantially horizontal when made with reference to the up/down directionality of the roller blind moving between retracted and advanced roller blind positions).

At least a bottom portion (or tail or foot) of the roller blind may comprise of the photovoltaic film (for example, when the roller blind is being unwound or advanced from a retracted position, at least a first portion of the roller blind advanced from a fully or completely retracted roller blind position, or in a fully wound-up or rolled-up position may comprise of the photovoltaic film, and a portion of the roller blind, for example a portion of the roller blind which may, in-use, more often remain substantially in a wound-up or unused or retracted position may be devoid of the photovoltaic film).

In accordance with at least one of the embodiments disclosed herein, in a second aspect there is provided a roller blind system, the roller blind system comprising:
a roller blind, the roller blind comprising of a photovoltaic film configured to, in-use, face towards an external face of a building envelope,
an energy storage system receivable of power generated from the photovoltaic film,
a motor connectable via a drive system for winding of the roller blind, the roller blind to be wound to an advanced or retracted position,
a controller configured to operate at least the motor for windingly advancing or retracting the roller blind to a desired extension position,
wherein in-use, a pre-determined length portion of said roller blind comprising of the photovoltaic film is left exposed.

According to the second aspect, the following details are provided:

The pre-determined length portion of said roller blind comprising of the photovoltaic film left exposed is a minimum surface area of photovoltaic film substantially sufficient for a minimum operation of the system (or for example for at least a minimum generation of photovoltaic energy and capture by or charging of the energy storage system).

The system of the second aspect, further comprising any one or more of the systems features as defined by the first aspect.

The system as defined by the first and/or second aspects, wherein one or more of a power conditioner, power distribution or other power modulation devices are utilised. Such devices can be provided on-board as part of the system, and not as a remote componentry or modules.

The system as defined by the first and/or second aspects, wherein the system uses a low voltage (for example, 12V) system. This may assist with improving electrical safety for installers and users.

The system as defined by the first and/or second aspects, wherein the power generated or stored by the energy storage system is configured to be entirely or substantially entirely used for the functionalities of the blind system, for example by providing power to one or more lights which can be integrated into the blind system, or as part of a housing or blind box configuration. In this manner, power generated by the photovoltaic film is then used in preference to for example provide lighting or illumination to a room or space, in preference to lighting provided in a room or space that is powered by the building power supply or mains electricity network. Accordingly, power requirements for a building or room or space can be reduced by effectively ‘off-boarding’ of the lighting power requirements to the lights provided by the blind system as defined herein. In relation to use of the power stored by the energy storage system, it will be appreciated that a small charge of power may be reserved by the blind system to enable the advancement or retraction of the roller blind.

Although it is to be appreciated that the blind system as defined herein is preferentially electrically independent and operationally electrically independent of a mains power supply, a charging port can be provided by the blind system to enable a charge or supply of power to operate light or a motorised blind in the event of a power failure or to provide an additional power source to operate functionalities of the system.

For example, to power lights at night if the power of the blind system is used up/runs out (i.e., depleted) or for additional redundancy of the system to allow for blind advancement or retraction, if needed.

In accordance with at least one of the embodiments disclosed herein, in a third aspect there is provided a roller blind system, the roller blind system comprising:
at least one first roller blind, and at least one second roller blind, to be installed in a substantially parallel configuration and arranged in a manner such that when in-use, the first roller blind is to be positioned relatively more outwardly, or toward a light source, than the second roller blind, and the second roller blind is to be positioned relatively more inwardly, or further away from the light source, than the first roller blind,
wherein at least one of the first roller blind(s) or the second roller blind(s), or both of the first roller blind(s) and the second roller blind(s), comprises of a photovoltaic film configured to, in-use, face towards a light source (such as an external face of a building envelope), and wherein each first roller blind(s) and the second roller blind(s) are independently operable, an energy storage system receivable of power generated from the photovoltaic film, a motor connectable via a drive system for winding of each of the first roller blind(s) and/or the second roller blind(s), each of the first and/or second roller blinds to be wound to an advanced or retracted position, a controller configured to operate at least the motor for windingly advancing or retracting each of the first and/or second roller blind(s) to a desired extension position.

The system, wherein in-use, a pre-determined length portion of at least one of the roller blind(s) comprising of the photovoltaic film is left exposed, for exposure to a light source.

The roller blind system may further comprise of a housing as a blind box or a pelmet-style covering (or enclosure) of the system.

The roller blind system may be of a dual (two) blind configuration.

The first roller blind(s) may comprise of the photovoltaic film, or a portion of the first roller blind may comprise of photovoltaic film.

The second roller blind(s) may comprise of the photovoltaic film, or a portion of the second roller blind may comprise of photovoltaic film.

The photovoltaic film of the first roller blind or the second roller blind, or the photovoltaic film of the portion of the first roller blind or of the portion of the second roller blind, may be substantially a tail or foot portion of the first roller blind and/or the second roller blind, and the photovoltaic film may extend substantially across the width of the roller blind, either partially or substantially wholly, across the width, or alternatively, or in addition, the photovoltaic film may extend substantially along the length of the roller blind, either partially or substantially wholly, along the length.

The second roller blind may be substantially a shade style roller blind.

The second roller blind may be substantially devoid of photovoltaic film.

A portion or portions (such as segmented portions or sections which may optionally be separated from each other) of the second roller blind may comprise of the photovoltaic film. Optionally, where a portion or portions of the extension length of the second roller blind comprises of photovoltaic film, the remainder of the extension length of the second roller blind may be devoid of photovoltaic film and may be of a shade style blind material.

The portion of the second roller blind comprising of the photovoltaic film may be a tail or foot (i.e., a bottom or lower part portion) of the second roller blind.

The portion of the second roller blind comprising of the photovoltaic film is about 95% or less of the extension length of the second roller blind, or may be about 90% or less, or may be about 80% or less, or may be about 75% or less, or may be about 70% or less, or may be about 60% or less, or may be about 50% or less, or may be about 40% or less, or may be about 30% or less, or may be about 25% or less, or may be about 20% or less or may be about 15% or less or may be about 10% or less, or may be about 5% or less of the extension length of the second roller blind.

The first roller blind may comprise of the photovoltaic film.

A portion or portions (such as segmented portions or sections which may optionally be separated from each other) of the first roller blind may comprise of the photovoltaic film.

The portion of the first roller blind comprising of the photovoltaic film may be about 100% or less of the extension length of the first roller blind, or may be about 95% or less, or may be about 90% or less, or may be about 80% or less, or may be about 75% or less, or may be about 70% or less, or may be about 60% or less, or may be about 50% or less, or may be about 40% or less, or may be about 30% or less, or may be about 25% or less, or may be about 20% or less or may be about 15% or less or may be about 10% or less, or may be about 5% or less of the extension length of the first roller blind.

The system, wherein of an extension length of the second roller blind, the second roller blind may comprise at least one portion of which comprises of the photovoltaic film and at least one other portion of which is of a shade style material (for example, may be devoid of the photovoltaic film), and wherein of an extension length of the first roller blind, the extension length of the first roller blind may be substantially comprised of the photovoltaic film.

The second roller blind may comprise of a portion of which comprises the photovoltaic film and the remainder of the extension length comprises of a shade style material (being devoid of photovoltaic film), and the first roller blind is substantially comprised of photovoltaic film.

The first roller blind may be configured as defined by the roller blind system in the first and/or second aspects.

The second roller blind may be configured as defined by the roller blind system in the first and/or second aspects.

The system as described above, wherein the first roller blind and the second roller blind may be configured in a single housing or enclosure as defined in the first and/or second aspects.

In relation to any one of the first, second or third aspects as defined above, where a photovoltaic film is provided as part of a roller blind, the photovoltaic film comprises of a front or face side which initially receives light or energy from a light or energy source, and back or rear side which comprises of a reflector for reflecting of received energy (such as from a light or energy source).

Any of the aforementioned features or embodiments or aspects may be combined with one or more of the other features or embodiments or aspects as described herein.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein the term “and/or” means “and” or “or”, or both.

As used herein “(s)” following a noun means the plural and/or singular forms of the noun.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The disclosure consists in the foregoing and also envisages constructions of which the following gives examples only. Features disclosed herein may be combined into new embodiments of compatible components addressing the same or related inventive concepts.

### BRIEF DESCRIPTION OF THE FIGURES

Preferred embodiments of the disclosure will be described by way of example only and with reference to the following drawings.

FIG. 1 shows a front (from an internal position) perspective illustrative view of an example embodiment of a roller blind system as disclosed herein.

FIG. 2 shows a rear or external side surface (from an external position) perspective illustrative view of an example embodiment of a roller blind system as disclosed herein.

FIG. 3 shows a plurality of roller blind systems as views from an internal position, illustrating how such an array or plurality of such roller blinds may be viewed, when arranged in a side-by-side or substantially adjacent type configuration, positioned in front of windows, W.

FIG. 4 shows a schematic of a first roller blind A which can be connected, either electrically or via a communications data link (or both) with another roller blind B, whether the second roller blind is a typical roller blind or a roller blind system as described herein. Shown also is the optional configuration of multiple further units, such as illustrated by unit N, being connectable to other roller blind units or roller blind systems.

FIG. 5 shows a front perspective view of a dual roller blind system.

FIG. 6 shows a rear perspective view of a dual roller blind system in a first configuration.

FIG. 7 shows a rear perspective view of a dual roller blind system in a second configuration.

FIG. 8 shows a plurality of dual roller blind systems as views from an internal position, illustrating how such an array or plurality of such roller blind systems may be viewed, when arranged in a side-by-side or substantially adjacent type configuration, positioned in front of windows, W.

FIG. 9A shows a schematic of a dual roller blind system with a first roller blind B1 and a second roller blind B2 in a first configuration.

FIG. 9B shows the schematic of a dual roller blind system of FIG. 9A in a second configuration.

FIG. 10A shows a schematic of a dual roller blind system with a first roller blind B1 and a second roller blind B2 in a first configuration.

FIG. 10B shows the schematic of a dual roller blind system of FIG. 10A in a second configuration.

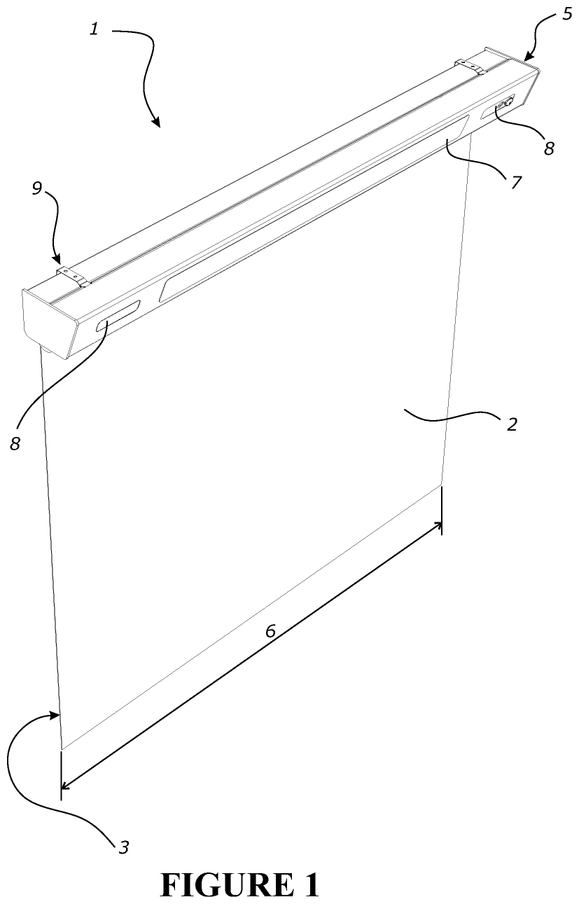

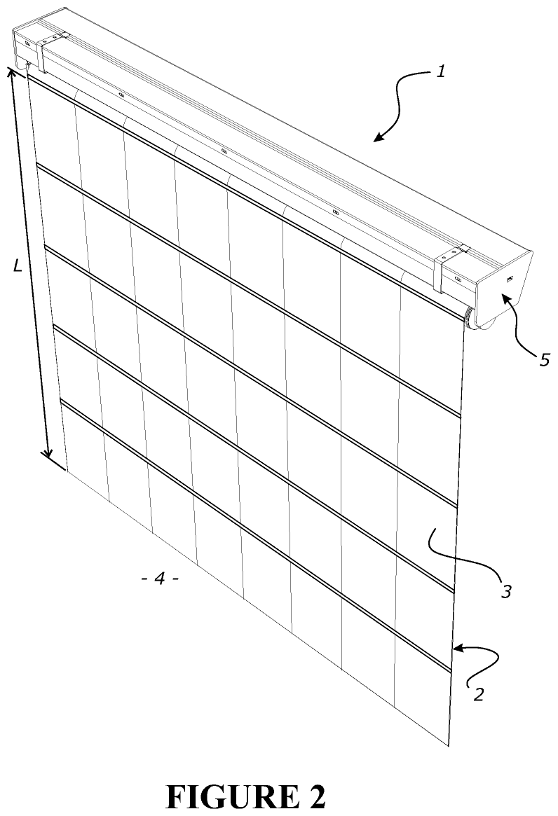

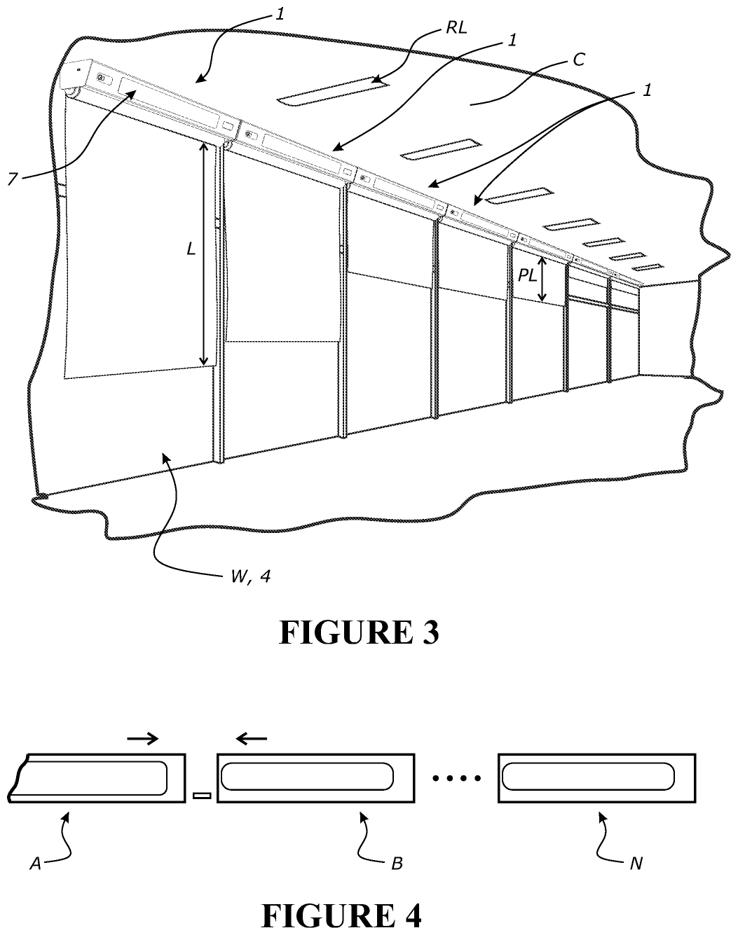

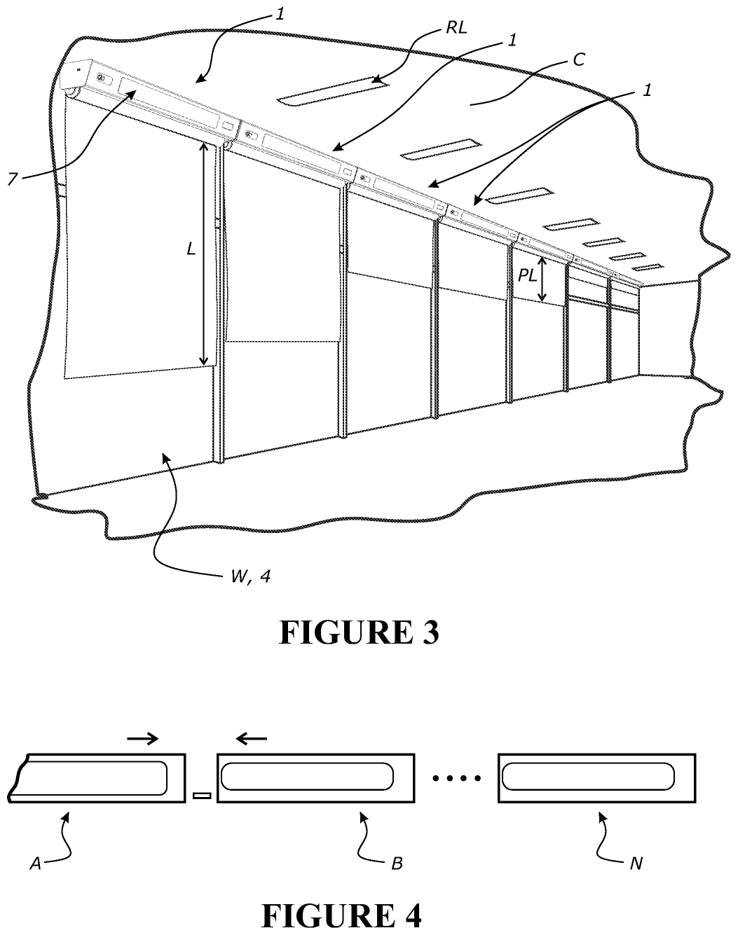

### DETAILED DESCRIPTION

Various embodiments are described with reference to the Figures. Throughout the Figures and specification, the same reference numerals may be used to designate the same or similar components, and redundant descriptions thereof may be omitted.

As described herein within various embodiments, is a roller blind system.

In a first embodiment, there is provided a roller blind system 1 comprising a roller blind 2, the roller blind 2 comprising of a photovoltaic film 3 configured to, in-use, face towards an external face 4 of a building envelope. An energy storage system (not shown, but would be within a housing 5 or blind box) receivable of power generated from the photovoltaic film 3. A motor (not shown, but would be within a housing or blind box) connectable via a drive system for winding of the roller blind 2, the roller blind 2 to be wound to an advanced or retracted position. A controller (not shown, but would be within a housing 5 or blind box) configured to operate at least the motor for windingly advancing or retracting the roller blind to a desired extension position or length, L.

In a second embodiment, there is provided a roller blind system 1 as described with reference to the first embodiment above, additionally wherein in-use, a pre-determined length (PL) portion of said roller blind 2 comprising of the photovoltaic film 3 is left exposed.

In a third embodiment, there is provided a roller blind system 1 substantially as described with reference to the first embodiment, additionally comprising one or more lights to 7 be powered by the energy storage system.

In a fourth embodiment, there is provided a system comprising one or more of the roller blind systems 1 as described with reference to any one of the first or second or third embodiments, wherein such a roller blind system 1 is electrically connectable or interconnectable to at least one further motorised blind to power such a further motorised blind(s).

The following details are provided with reference to the above-described embodiments, the accompanying figures and claims.

A roller blind system 1 is advantageously provided which is a capable of being provided in a ready-to-go configuration, whether as a single unit or module or as a series of units or modules which can be readily connected or assembled to each other either at the factory or on-site.

Such a system 1, can be provided to be a fully portable configuration for each of installation and removal as required, yet which is independent and capable of substantially generating sufficient power to operate a motor for advancing or retracting a roller blind. Additionally, the inclusion of one or more lights 7 into such a system 1 can allow for a roller blind system to both control light within a room or space by advancing or retracting the roller blind itself, but also to operate one or more lights 7 to artificially illuminate the room or space. In this manner, power can be generated by the photovoltaic film 3 and can be used by the system 1.

Such a system 1 may be operated at a relatively low voltage for consumer or installer or site-specific safety considerations, for example as a 12 Volt system. Although other voltage systems may be employed as desired.

Industrial, commercial, residential, and other buildings, including in agricultural or pastoral situations, may all utilise roller blinds or rolled screen systems to control the amount of light or solar radiation entering a building or space. Provision of a rolled blind system that integrates a photovoltaic film 3 (a substantially flexible film) with the blind itself allows for particular benefit in that solar control of the light entering a space is enabled, yet the dual benefit of power generation can be enabled when a blind is moved from a fully retracted position (or rolled or wound-up configuration) to a more advanced (extended) (or unwound or unrolled configuration) position. Power generated from this configuration may be utilised by the system depending on a user's needs.

However, in one particular configuration, one or more lights 7 may be integrated with the blind system 1. For example, as part of a housing 5 into which the roller blind is provided, or as part of a blind box (a blind box typically refers to the housing 5 within which a roller blind is provided or protected or aesthetically hidden from view). The housing 5 may be of a pelmet-style shape.

Accordingly, provision of one or more lights 7 (such as LED type lights), which are powered by power generated from the photovoltaic film (optionally stored in the energy storage system) allows for control of the illumination levels within a room or space. For example, a roller blind may be in a partially or fully extended state or position, and the photovoltaic film 3 is then exposed for receiving light passing through a window W or other light transmissible material (for example could be a polymer or glass or other material). During daylight hours, with a photovoltaic film exposed, power can be generated and stored for use. When solar radiation levels are relatively high, or during relatively environmentally warm days (or for any other reason), or generally bright light conditions, a roller blind can be partially or fully extended to control the natural light entering a building through the windows. This can help to reduce light and solar gain in the room or space. Yet, simultaneously, power can be generated.

Where for example the roller blind reduces light levels to below a desired internal light level, rather than retracting a roller blind to let more natural light (and solar gain) into the room or space, power generated from the photovoltaic film 3 can be used to power one or more lights 7 to artificially illuminate the room or space.

Such a roller blind system 1 as described herein may be utilised as a part of a plurality of typical motorised roller blinds, for example (depending on the power requirements of the typical motorised blinds), one or more of the roller blind systems as described herein may be utilised to provide the power source for operating the other typical motorised roller blinds. In this manner, a roller blind comprising of the photovoltaic film 3 can be a power generating blind system 1 which can be electrically connected or other inter-connects through suitable means to other typical motorised roller blinds. Such connection between blinds may be via various electrical connection systems. Data connections may also be provided for, for example for the sharing of control systems so that blinds or lighting or other devices can be collectively or simultaneously controlled.

Similarly, two or more roller blind systems 1 as described herein can be operationally (such as electrically) connected to each other. For example, a roller blind system 1 such as that described herein may face higher or lower sunlight levels at certain times of the day than other blinds, and so power sharing may be utilised across a network or array of blind systems to allow for, collectively, power distribution as needed amongst the network or array.

Provision of the one or more lights 7 allows for use of the power generated by the photovoltaic film 3. In this way, power requirements of a building or facility or room or space can be reduced by effectively reducing the need for mains or building powered lighting with a room or space. Artificial lighting within a building or room or space can account for a reasonable amount of total power usage in buildings. Any reduction in total power usage of a building is beneficial.

Such a housing 5 or blind box may integrate one or more lights 7.

The photovoltaic film to be utilised is ideally a substantially flexible film. In this way, the flexible film can be wound up into a roll, as part of a roller blind and capable of being repeatedly wound up and unwound, substantially suitable for repeated use without performance degradation.

The roller blind and photovoltaic film can be attached or connected to each other. For example, where these are multiple layers, these layers may be laminated together, or may be glued or adhered to each other, or may be sewn or stitched to each other, this includes the use of mechanical connections as well as heat forming attach or connect or otherwise join a blind material to a photovoltaic film.

It will also be appreciated that the photovoltaic film may itself be the blind material, or a separate blind material or layer may be provided upon which the photovoltaic film is connected or attached. In such instances, colours or patterns or other decoration may be applied to an internal (i.e., room/space facing) side of the photovoltaic film or a blind material if a blind material is to be provided as a separate layer to that of the photovoltaic film. This may include tints, colours etc.

The photovoltaic film 3 may extend substantially across the width 6 of the roller blind, or may extend partially across the width 6 of the roller blind, either partially or substantially wholly, across the width. Alternatively, or in addition, the photovoltaic film may extend substantially along the length of the roller blind, either partially or substantially wholly, along the length. As noted above, an internal (i.e., room) facing side of the photovoltaic film 3 may optionally comprise of a decorative or non-decorative ornamentation.

Where a decorative or non-decorative ornamentation is provided, this may be in the form of a printed layer or a laminated layer or otherwise attached or applied layer of material to the internal (i.e., room) facing side of the photovoltaic film.

As noted above, the internal (i.e., room) facing side of the roller blind may comprise of a tinted or non-tinted or coloured layer.

The photovoltaic film may comprise of the decorative or non-decorative layer as a layer of the photovoltaic film or may comprise of a tinted or non-tinted or coloured layer as a layer of the photovoltaic film.

The energy storage system (not shown, but hidden from view within the housing 5) can comprise one or more batteries. The energy storage system having sufficient capacity to store all of the energy generated by the photovoltaic film on a daily basis.

The system 1 can be provided in a “ready-to-go” type configuration with the energy storage system factory installed with at least a minimum charge of power for an initial operation or initial configuration on-site, or an immediate use capability. The energy storage system may be factory charged but may require a simple on-site step to safely allow the energy storage system to be actively made a part of an electrical circuit (for example, a strip of non-conductive material may be provided to prevent an electrical circuit from being made between the energy storage system and the remainder of a power or control system. Alternatively, the energy storage system may be provided as a separate unit or module which can be relatively easily connected or installed into an in-use position on-site. Alternatively, the energy storage system may be provided in a disconnected condition, awaiting final installation or connection on-site at installation.

In various embodiments, it would be advantageous to provide the system, or a series of units or modules for easy assembly on site. Alternatively, the system is provided for on-site installation in a pre-assembled or “ready-to-go” type configuration.

Although it is anticipated the system 1 as described herein is planned to be electrically independent of a building's power supply or wiring system, a charging port may be provided to allow for an emergency or top-up charge of power to said on-board energy storage system, or alternatively the charging port may be provided to extract power from the energy storage system (for example in an emergency use situation or as a remote charging of device function). This provides for some redundancy.

The charging port may be any form of electrical connection, but in one example may be in the form of a universal serial bus (USB) port, or may be other electrical port configurations configured to receive or provide power and/or a data link. For example, power over ethernet (POE) may be utilised.

Where the system 1 comprises the one or more lights 7, these may be provided to assist with illuminating a room or space within which said system is installed. The lights 7 can be provided about or within the housing 5. For example, the housing 5 may comprise one or more apertures (also identified as 7 on the housing 5) through which the light from the one or more lights is to be projected or directed.

A diffuser can be provided across the face of the one or more lights or across the face of the one or more apertures to diffuse the light.

One or more lights, or groups of lights, can be provided with a reflector positioned behind the light or group of lights. The light or lights to be positioned in front of the reflector, optionally with a diffuser positioned in front of the light, and optionally such an arrangement of a reflector and light is provided within the housing 5 (such as a blind box, or pelmet-style blind box arrangement).

The reflector can be selected to help with projecting or directing of light substantially across a room or space or toward a ceiling of the room or space, to help with distribution of light across the room or space.

The controller (not shown, but integrated into circuitry and located within the housing 5) can be used to controllably and selectively adjust the brightness or luminous flux (or lumens) emitted by the one or more lights.

In one embodiment, a siding or face of the housing 5 can comprise one or more apertures to allow emittance of the one or more lights.

In another embodiment, it may be advantageous to position the at least one of the one or more lights so as to project or direct light upwardly towards a ceiling of the room/space within which said system is to be installed.

For example, at least one of the one or more lights can be provided on an interior facing side surface of the housing (i.e., an interior room/space facing direction). In another example, at least one of the one or more lights can be provided on a top (or ceiling) facing side surface of the housing (i.e., a top surface of the housing which would typically face upwards towards a ceiling).

In the example where the one or more lights are provided on an interior facing side surface of the housing, such a side surface can be angled such that a top edge of the housing extends horizontally beyond (or further outward than) a lower edge of the housing. This creates an angled face.

In various embodiments, one or each light or group of lights can be provided with a reflector, the light positioned in front of the reflector, optionally a diffuser positioned in front of the light, and optionally such an arrangement of a reflector and light is provided within a housing or within a body of a pelmet-style blind box arrangement.

In various embodiments, the system 1 comprises a sensor or sensors 8 for measurement and/or detection of one or more room conditions.

The one or more room conditions may be one or more of: motion or activity within a room/space (for example, occupancy), light level within a room/space (for example, ambient flux levels within the room/space), external ambient light level, combinations of room/space and external light levels, temperature of a room/space, a timer schedule based upon a time-of-day or day of week, a manual signal input from a user, gestures from a user (such as macro or micro physical gestures from a user), voice or other audible sounds from a user (such as voice or audible sound activation or control or commands, directly or indirectly, via one or more devices capable of measuring or detecting such sounds).

The controller can operate to adjust one or more of the following:
the motor to adjust the roller blind or screen to a desired extension position based upon one or more of the room conditions, for example to reduce light levels within a room/space or reduce incoming external light (e.g., sunlight as the light source),
the light output level in response to ambient light conditions (e.g., a light output may be ramped up or ramped down as needed, or to provide for a slow or soft start or slow or soft finish to turning the one or more lights on or off).

The controller can operate to adjust based upon a measured or detected room condition.

For example, the room conditions can be measured or sensed by one or more sensors integrated with the system or as part of the housing. Such measuring or sensing can be by one or more sensors provided remotely about a room/space, and providing a signal back to the controller (e.g., the remote sensor or sensors may communicate with the controller via a wired or wireless communication link).

In some configurations, a manual input from a user can be sent, for example a signal can be sent to/received by, a sensor or the controller, to manually provide a desired extension position of the roller blind.

A user may also manually set or adjust, from a default setting, a preferred light level within a room or temperature of a room or based upon the amount of motion or level or activity within a room over a period of time, or may adjust a pre-determined timer schedule or other automatic adjustment based upon a measured or detected room/space condition. For example, a seasonal adjustment based upon seasonal light source levels may be used to adjust a set point or a pre-determined extension position of the roller blind comprising of the photovoltaic film to a pre-determined length portion

The controller may account for both sensed and measured room conditions itself, and take into account user input settings or control signals.

The signal from a user for the manual setting or adjustment may be communicated via a data communication link or network protocol via a wired or wireless communication or network or combination thereof (examples include, but are not limited to: NFC, wi-fi, Bluetooth, LTE, Zigbee communication link or network protocol enabled systems).

It will also be appreciated that manual adjustment may be provided for via a control panel or switching on a housing or other associated controller of the system (for example may have an on/off switch, or other touch panel or control access).

Advantageously, the roller blind system 1 is to be provided as a single unit configured for fastening or fixing into position (for example, the system can be fastened or fixed into a position to cover (partially or substantially wholly) a window or other sunlight light transmitting medium, including but not limited to one or more of: glass, polymers, composite materials). One example of a fastening or fixing system is a mechanical bracket 9 which may be provided which can be attached via screws to a wall or frame of a window or ceiling of a room.

In some embodiments, the system 1 is configured as a single module or a plurality of modules (optionally one or more of which may be directly or indirectly connected or connectable with one or more other modules) which can either be factory pre-assembled or assembled on site.

In some embodiments, the system 1 is provided as a single module without the need for additional on-site assembly or other connections, or is provided as a single completed unit in a ready-to-ship or ready-to-install configuration.

Alternatively, the system 1 may be provided as a multi-module configuration, comprising first module as a housing 5, a second module as a rolled-up blind, and a third module as an energy storage system pack (such as a battery pack).

The system 1 or controller of the system 1, may be enabled to communicate with or be provided in communication with, a building management system (BMS), or receive control signals or be controllable via a BMS.

When the blind system is in an in-use or installed configuration, the blind is wound in a configuration such a portion of photovoltaic film 3 remains exposed, exposed to an external face of the building envelope. In this manner, even when the blind is entirely wound up, a small portion of the photovoltaic film may be left exposed. This may allow for some small amount of charging or power generation even when the system is installed, but the unit has now been activated. In a further alternative, once a system has been installed and a unit has been activated, there may be a default setting in which a small portion or length of the blind may be unwound or advanced from a completely wound-up state (such as during transport), to provide for a minimum length portion which may need to be exposed to generate some power or charge from the photovoltaic film 3 which is then exposed to light.

For example, a portion of the photovoltaic film can remain exposed to, in-use, face towards an external face of a building envelope, even when in a fully or completely retracted blind position.

For example, a pre-determined length portion LP of the roller blind including the photovoltaic film 3, is left exposed (for example, for generation of photovoltaic energy and/or capture by said energy storage system).

In-use, a pre-determined length portion of said roller blind including the photovoltaic film, can be left advanced from a fully or completely retracted position (for example, for generation of photovoltaic energy and/or capture by said energy storage system). Such a pre-determined length portion may be self-adjusted by the controller over time as the controller learns the charge generated by different surface areas of the photovoltaic film left exposed at different times of the day or season, or the system or controller may be pre-programmed with particular values depending on geographical location or may be linked in to weather forecasting.

In further embodiments, the system can be pre-programmed to, upon initial set up, wind said roller blind or screen to a pre-determined extension length or position (for example, to an advanced or retracted position). This may for example be the pre-determined length PL, or may be a longer length, L.

An in-use maximum retracted position of the blind can be provided for a pre-determined minimum extension length substantially sufficient to enable a minimum power generation or charge of power for use by the system (for example or to be retained by the energy storage system). For example, the system 1 may be configured to ensure that a tail remains hanging out of the housing 5 to leave a portion of the photovoltaic film 3 exposed for power generation. In this respect, the portion of the blind, such as the pre-determined length portion PL once installed or when in an in-use configuration, remains exposed to provide for a trickle charge capability of the energy storage system.

A minimum exposed surface area of the photovoltaic film 3 left exposed may self-adjust based upon a minimum required trickle charge or minimum stored power requirement of the energy storage system. For example, the minimum exposed surface area of the photovoltaic film left exposed may self-adjust based upon seasonal changes to account for a minimum required trickle charge or minimum stored power requirement of the energy storage system.

Although the energy storage system can be battery, other electrical energy storage device(s) may be used.

In further embodiments data relating to one or more sensed room conditions may be provided to a building management system (BMS) or other control system.

A plurality of the roller blind systems 1 may be provided and two or more of these may substantially operate as to a retracted or advanced blind length or position (or length of extension) or to substantially match a blind position. For example, at least two or more systems may operate as to a communal or communally retracted or advanced blind length or position (or length of extension). In this manner, an array or network, or networked setup, of a plurality of roller blind systems 1 may be provided.

In relation to the photovoltaic film 3, such film 3 may cover substantially all or substantially a partial surface area of the blind (for example, to enable some light to pass the blind).

The photovoltaic film 3 may be itself provided as a pattern across the blind (for example, as a series of stripes, whether at an angle or substantially vertical or substantially horizontal when made with reference to the up/down directionality of the blind moving between retracted and advanced blind positions).

In some embodiments, at least a bottom portion (or foot) of the blind may comprise of the photovoltaic film. For example, when the blind is being unwound or advanced from a retracted position, at least a first portion of the blind advanced from a fully or completely retracted blind position ma comprise of the photovoltaic film, and a portion of the blind, for example a portion of the blind which may, in-use, more often remain substantially in a wound up or unused or retracted position may be devoid of the photovoltaic film.

In other embodiments, the roller blind system 1 as described herein may be coupled or inter-connected to other motorised roller blind units to receive their power from the system 1. For example a unit A can be connected to a unit B as shown in FIG. 4. Further units N are desired can be connected. Interconnects may be different types of electrical or data connectors or both, to help facilitate coordinated or networked control of blind control or lighting control.

The system 1 as described herein can provide for a source of emergency power (via a charge port) and/or lighting. For example, during a power cut, such a system is electrically independent and can operate lights to illuminate the room or space as needed.

The one or more lights may also project or direct light downwardly across a room or space.

The system described herein provides for a portable unit which is retrofittable for new and older buildings or spaces.

The system described herein may preferably be of a maximum operative voltage of 30 Volts or less but will depend upon application.

Multiple units may be interconnected with each other in series or parallel depending upon required power configurations.

The power generated can be monitored and data stored relating to power generation capabilities. This can be fed into a system controller to refine operating parameters such as length or surface area of photovoltaic film which may need to be left exposed for a minimum power generation capability. Solar tracking capabilities may also be included to help with determining a network configuration for one or more blinds to help with improve efficiencies of power generation and/or light control into a room or space.

In various embodiments, power generated or stored each day or cycle of light/dark is used up by the one or more lights. In this way, power usage for artificial lighting in a room or space can be minimised or substantially reduced by ensuring the power generated each day is substantially used up.

Such a system may be connectable to cloud-based or internet systems to allow for remote monitoring or control or network capabilities.

In addition to the above description, the details of which can be incorporated into further roller blind systems. For example, roller blind systems which comprises of two or more roller blinds, often arranged parallel with each other in what is known as a ‘dual blind’ configuration. Such multi-blind systems may typically provide for one of the roller blinds to provide for some shading characteristics (such as the second roller blind B2), whilst still allowing some light to pass through its blind material, whilst another roller blind (such as the first roller blind B1), may be used as a complete inhibitor of light transfer, indeed is used as a block blind or black-out type blind to substantially inhibit passage of nearly all light.

Advantageously, either one roller blind on its own (such as a first roller blind B1 when provided as a photovoltaic film roller blind), or a combination of two blinds (such as a first roller blind B1 and a second roller blind B2), operate to substantially inhibit or block nearly all light from coming into the building or space (e.g., sunlight, streetlights), as well as light from exiting out of the building or space comprising of such a roller blind system (such as internal lighting). In this manner, light blocking is provided in both directions (blocked or inhibited from entry into the building or space, as well as from light exiting the building or space). This can provide a secondary function of providing for privacy within the building or space (such as bedrooms or other spaces which may need to be private).

In one example mode of operation of a dual roller blind system, the second blind B2 can be in an extended length position to provide shade and if it includes a portion which comprises of photovoltaic film (such as a tail or foot portion), then shade and some PV generation can occur, whilst the first roller blind B1 is in a retracted position. In a further example mode of operation, the first roller blind B1 can be wound to an extended or extension length position to provide additional PV generation, as well as additional light blocking (or privacy). During nighttime, both of the first roller blind B1 and the second roller blind B2 can be in extended or extension length positions to provide light blocking from both outside/external (to prevent or inhibit streetlight/external light during night and sunlight in morning, and also stopping inside building light exiting to outside), as well as a privacy function during evening and night, but may also include daytime too for privacy purposes.

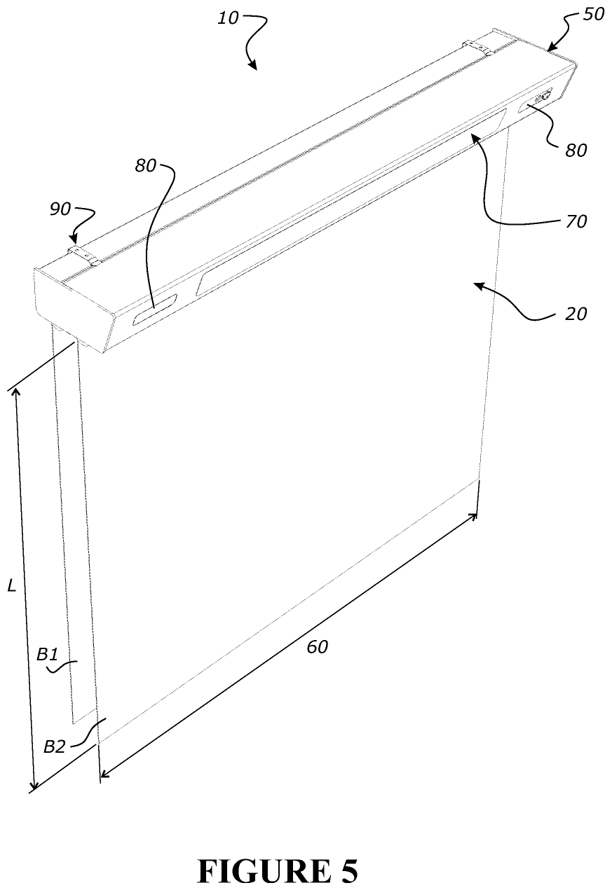

With reference to FIGS. 5-10B, the following embodiment is such a multi-blind configuration, and yet each roller blind may be configured or operable as part of a roller blind system as described in the aforementioned embodiments.

In such a further embodiment, there can be provided a roller blind system 10, comprising of at least one first roller blind B1, and at least one second roller blind B2, to be installed in a substantially parallel configuration and arranged in a manner such that when in-use, the first roller blind B1 is to be positioned relatively more outwardly, or toward a light source 40, than the second roller blind B2, and the second roller blind B2 is to be positioned relatively more inwardly, or further away from the light source 40, than the first roller blind B1.

At least one of the first roller blind(s) B1 or the second roller blind(s) B2, or both of the first roller blind(s) and the second roller blind(s), comprises of a photovoltaic film 30 configured to, in-use, face towards a light source 40 (such as an external face of a building envelope). Each first roller blind(s) and the second roller blind(s) are independently operable, and an energy storage system is receivable of power generated from the photovoltaic film. A motor is also connectable via a drive system for winding of each of the first roller blind(s) and/or the second roller blind(s), each of the first and/or second roller blinds to be wound to an advanced or retracted position, with a controller configured to operate at least the motor for windingly advancing or retracting each of the first and/or second roller blind(s) to a desired extension position. A full extension length indicated as L in the Figures.

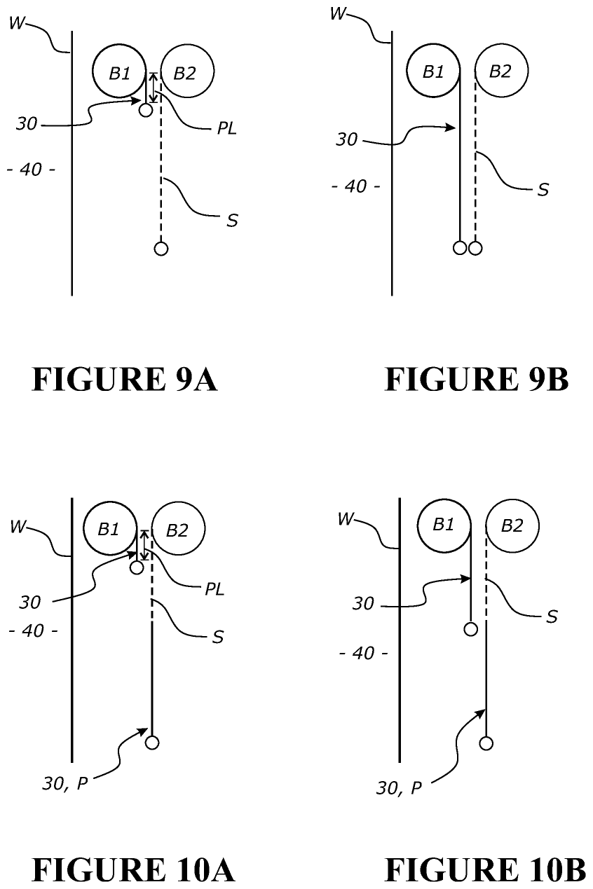

In some embodiments, in-use, a pre-determined length portion of at least one of the roller blind(s) comprising of the photovoltaic film 30 is left exposed, for exposure to a light source to generate a minimum charge or power requirement of the system. See for example FIGS. 9A and 10A which illustrate such a portion of photovoltaic film 30 on the roller blind B1 as an extended portion from a completely wound-up configuration. Such a configuration provides for a small length or tail portion to remain exposed for generation of a charge or power, which may be sufficient to meet a minimum power requirement of the system, such as for operation of a light of the enclosure or housing or to operate the motor to advance or retract the roller blind (B1 or B2) to a desired extension length.

FIGS. 9A and 9B illustrate a configuration where the second roller blind B2 is a shade style blind only and operates to provide shade capability when desired, whilst the first roller blind B1 comprises of photovoltaic film 30 and operates to provide power generation and also a layer of shading to the interior of the building due to the light blocking characteristics of photovoltaic film. In this configuration, a first (but partial) shading of the interior of the building can be provided by the first roller blind B1 with the small length of tail or foot of photovoltaic film exposed, and an additional layer or shading can be provided by the second roller blind B2. FIG. 9B illustrates the configuration of FIG. 9A when the first roller blind B1 is then extended further for greater shading of the interior of the building (i.e., light blocking capabilities), with the added benefit of greater power generation by the PV film.

FIGS. 10A and 10B illustrate a similar configuration to that of FIGS. 9A and 9B, but the second roller blind B2 has a portion P which comprises of photovoltaic film, and a remainder of the second roller blind B2 is devoid of the photovoltaic film 30, but has shading capability (to reduce transmission of light, but still allows some light to pass through, as indicated by the dotted lines of the blind B2). In this way, the first roller blind B1 operates to generate power when in an initial extended position or when the photovoltaic film is exposed to the light source 40, and yet when in a fully or more extended extension position (such as is shown in FIG. 10B), may provide for more light blocking capabilities to inhibit light (and thermal energy) from entering the building, with the added benefit of greater power generation by the power generated from the PV film on the portion of the second roller blind B2, in addition to the power generated by the PV film exposed to the light source 40 from the first roller blind B1. By providing the second roller blind B2 with a tail or foot portion which is in a pre-determined exposure position to also generate some power, power can be generated and yet some light allowed to pass through int the building. Yet, if greater light inhibition is wanted, or more power generation is required, the first roller blind B1 can be extended (lowered) to expose more PV film and in doing so provide for increased light inhibition and increased power generation.

A further advantage of the use of the photovoltaic film incorporated into a roller blind is that the rear side (i.e., non incoming light side) of solar cells comprises of a rear reflector, typically located behind the solar active material, often made of a layer of deposited silver or aluminium or other suitably reflective material, and this acts as a reflector to reflect energy back outside (i.e., back toward the light or energy source). Such energy is electromagnetic energy or infra-red energy. Energy which is not able to be converted to electricity by the solar cells (i.e., PV film) is reflected back toward the source, for example back out the window glass and back out of the building. This can be particularly beneficial in warm climates to further reflect thermal energy to help reduce the solar thermal gain of a building.

The roller blind system may further comprise of a housing as a blind box or a pelmet-style covering (or enclosure) 50 of the system. Such a housing or enclosure 50 is that as described above, and can house multiple blinds, such as the first and second blinds B1, B2. The housing or enclosure is advantageously that as described previously, for example including the one or more apertures and lights and sensors 70, 80.

The roller blind system may be specifically of a dual (two) blind configuration. The first roller blind(s) B1 may comprise of the photovoltaic film 30, or a portion P of the first roller blind may comprise of photovoltaic film 30, or the first roller blind may be entirely devoid of photovoltaic film (for example may be entirely of a shade style material, S).

The second roller blind(s) B2 may comprise of the photovoltaic film 30, or a portion P of the second roller blind may comprise of photovoltaic film 30.

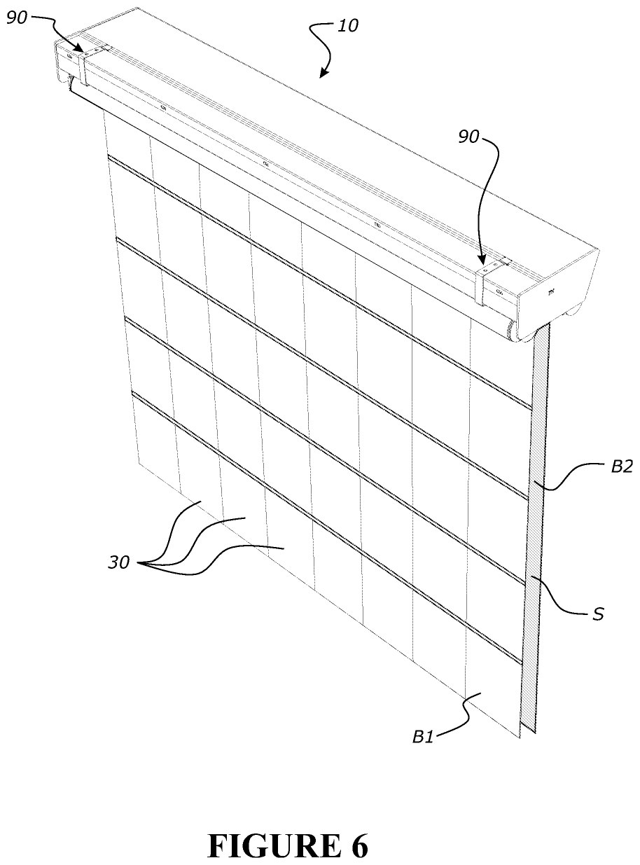

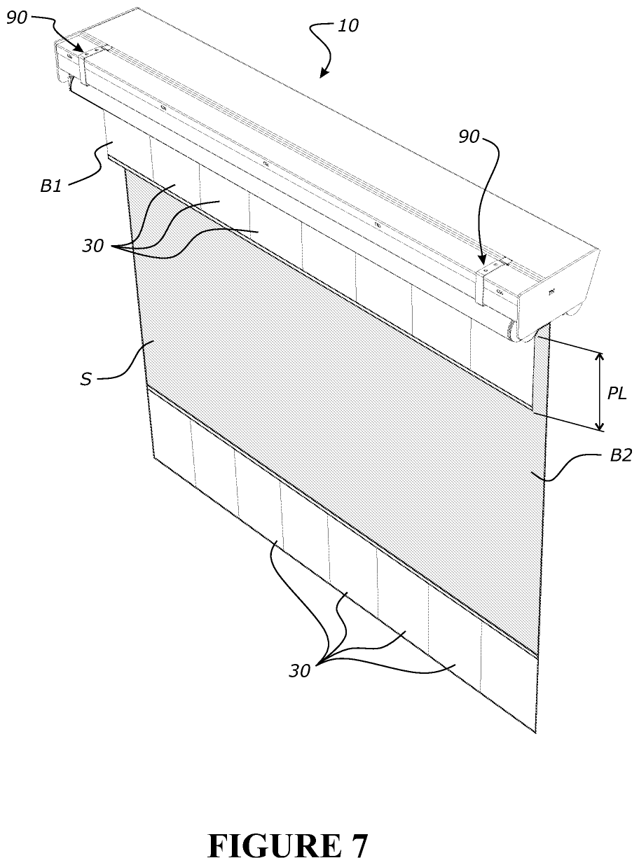

FIG. 5 illustrates a dual blind configuration with a first blind B1 and a second blind B2, to be housed within an enclosure 50. The enclosure 50 is that as previously described as item 5 in the above embodiments, and comprises lights 70 and sensors 80. The blinds B1, B2 can have a width 60, and a full extension length L. Brackets 90 can be provided for affixing such an enclosure in a position. FIG. 6 illustrates FIG. 5 in more detail, and shows the second blind BB as a shade style blind material S, with the first blind B1 comprising of the photovoltaic film 30. FIG. 7 illustrates a further alternative configuration, in which a portion P of the second roller blind B2 comprises of photovoltaic film 30, with the remainder of the blind B2 being of a shade style blind material S, while the first roller blind B1 has a photovoltaic film portion 30 which is hanging exposed a pre-determined length portion and operational for power generation.

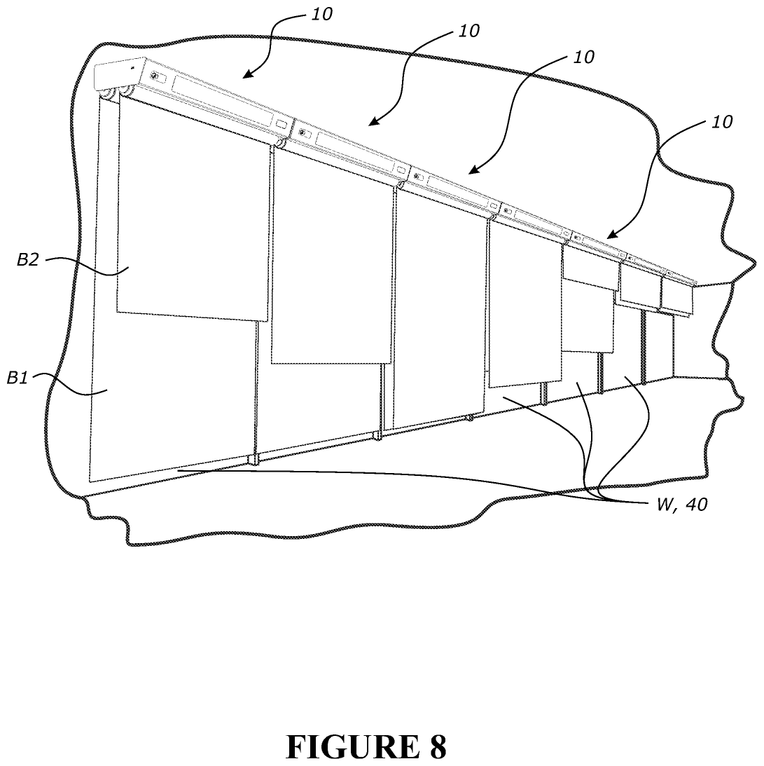

FIG. 8 illustrates a plurality of modules of roller blind systems configured as dual blind systems.

The photovoltaic film of the first roller blind or the second roller blind, or the photovoltaic film of the portion of the first roller blind or of the portion of the second roller blind, may be substantially a tail or foot portion of the first roller blind and/or the second roller blind, and the photovoltaic film may extend substantially across the width of the roller blind, either partially or substantially wholly, across the width, or alternatively, or in addition, the photovoltaic film may extend substantially along the length of the roller blind, either partially or substantially wholly, along the length.

The second roller blind may be substantially a shade style roller blind, or may be substantially devoid of photovoltaic film.

A portion or portions (such as segmented portions or sections which may optionally be separated from each other) of the second roller blind may comprise of the photovoltaic film. Optionally, where a portion or portions of the extension length of the second roller blind comprises of photovoltaic film, the remainder of the extension length of the second roller blind may be devoid of photovoltaic film and may be of a shade style blind material.

The portion of the second roller blind comprising of the photovoltaic film may be a tail or foot (i.e., a bottom or lower part portion) of the second roller blind.

The portion of the second roller blind comprising of the photovoltaic film is about 95% or less of the extension length of the second roller blind, or may be about 90% or less, or may be about 80% or less, or may be about 75% or less, or may be about 70% or less, or may be about 60% or less, or may be about 50% or less, or may be about 40% or less, or may be about 30% or less, or may be about 25% or less, or may be about 20% or less, or may be about 15% or less, or may be about 10% or less, or may be about 5% or less of the extension length of the second roller blind.

The first roller blind may comprise of the photovoltaic film.

A portion or portions (such as segmented portions or sections which may optionally be separated from each other) of the first roller blind may comprise of the photovoltaic film.

The portion of the first roller blind comprising of the photovoltaic film may be about 100% or less of the extension length of the first roller blind, or may be about 95% or less, or may be about 90% or less, or may be about 80% or less, or may be about 75% or less, or may be about 70% or less, or may be about 60% or less, or may be about 50% or less, or may be about 40% or less, or may be about 30% or less, or may be about 25% or less, or may be about 20% or less, or may be about 15% or less, or may be about 10% or less, or may be about 5% or less of the extension length of the first roller blind.

The system, wherein of an extension length of the second roller blind, the second roller blind may comprise at least one portion of which comprises of the photovoltaic film and at least one other portion of which is of a shade style material (for example, may be devoid of the photovoltaic film), and wherein of an extension length of the first roller blind, the extension length of the first roller blind may be substantially comprised of the photovoltaic film.

The second roller blind may comprise of a portion of which comprises the photovoltaic film and the remainder of the extension length comprises of a shade style material (being devoid of photovoltaic film), and the first roller blind is substantially comprised of photovoltaic film.

The first roller blind may be configured as defined by the roller blind system in the first and/or second aspects.

The second roller blind may be configured as defined by the roller blind system in the first and/or second aspects.

The system as described above, wherein the first roller blind and the second roller blind may be configured in a single housing or enclosure as defined in the first and/or second aspects.

Where, in the foregoing description reference has been made to integers or components having known equivalents thereof, those integers are herein incorporated as if individually set forth.

Although the present disclosure has been described in terms of certain embodiments, other embodiments apparent to those of ordinary skill in the art also are within the scope of this disclosure. Thus, various changes and modifications may be made without departing from the spirit and scope of the disclosure. For instance, various components may be repositioned as desired. Moreover, not all of the features, aspects and advantages are necessarily required to practice the present disclosure. Accordingly, the scope of the present disclosure is intended to be defined only by the claims that follow.

1. A roller blind system comprising:
a roller blind, the roller blind comprising of a photovoltaic film configured to, in-use, face towards an external face of a building envelope,
an energy storage system receivable of power generated from the photovoltaic film,
a motor connectable via a drive system for winding of the roller blind, the roller blind to be wound to an advanced or retracted position,
a controller configured to operate at least the motor for windingly advancing or retracting the roller blind to a desired extension position.

2. The system of claim 1, wherein the photovoltaic film is a substantially flexible film.

3. The system of claim 1 or 2, wherein the roller blind and photovoltaic film are attached or connected to each other.

4. The system of any one of claims 1-3, wherein the roller blind and photovoltaic film are laminated together, or glued or adhered to each other, or sewn or stitched to each other.

5. The system of any one of claims 1-4, wherein the photovoltaic film extends substantially by either or both of: across the width of the roller blind, or may extend partially across the width of the roller blind, either partially or substantially wholly, across the width, or the photovoltaic film may extend substantially along the length of the roller blind, either partially or substantially wholly, along the length.

6. The system of any one of claims 1-5, wherein an internal facing side of the photovoltaic film comprises of a decorative or non-decorative ornamentation.

7. The system of any one of claims 1-6, wherein the decorative or non-decorative ornamentation is a printed layer or a laminated layer or otherwise attached layer of material to the internal facing side of the photovoltaic film.

8. The system of any one of claim 1-7, wherein the internal facing side of the roller blind comprises of a tinted or non-tinted or coloured layer.

9. The system of any one of claims 1-8, wherein the photovoltaic film comprises of the decorative or non-decorative layer as a layer of the photovoltaic film or comprises of a tinted or non-tinted or coloured layer as a layer of the photovoltaic film.

10. The system of any one of claims 1-9, wherein the energy storage system comprises one or more batteries, optionally the energy storage system has sufficient capacity to store all of the energy generated by the photovoltaic film on a daily basis.

11. The system of any one of claims 1-10, wherein the system is provided in a ready-to-go configuration with the energy storage system factory installed with at least a minimum charge of power for an initial operation or initial configuration on-site, or an immediate use capability.

12. The system of any one of claims 1-11, wherein the system is provided for on-site installation in a pre-assembled or ready-to-go configuration.

13. The system of claim 12, wherein the energy storage system is provided in a disconnected condition, awaiting final installation on-site.

14. The system of any one of claims 1-13, further comprising a charging port to provide a charge of power to said on-board energy storage system, or alternatively the charging port is provided to extract power from the energy storage system (for example in an emergency use situation or as a remote charging of device function).

15. The system of claim 14, wherein the charging port is a universal serial bus (USB) port, or is other electrical port configurations configured to receive or provide power and/or a data link.

16. The system of any one of claims 1-15, wherein said system is electrically independent of a building power supply or building wiring system, or is electrically connected, or connectable, to a building power supply or building wiring system to enable one or more lights to operate if the energy storage system does not have sufficient charge.

17. The system of any one of claims 1-16, further comprising of a housing as a blind box or a pelmet-style covering of the system.

18. The system of any one of claims 1-17, further comprising one or more lights.

19. The system of claim 18, wherein the one or more lights are provided to assist with illuminating a room or space within which said system is installed.

20. The system of claim 18 or 19, wherein the one or more lights are provided about or within the housing.

21. The system of any one of claims 18-20, wherein the housing comprises one or more apertures through which said light from the one or more lights is projected or directed.

22. The system of any one of claims 18-21, wherein a diffuser is provided across the face of the one or more lights or across the face of the one or more apertures to diffuse the light.

23. The system of any one of claims 18-22, wherein the controller adjusts the brightness or luminous flux (or lumens) emitted by the one or more lights.

24. The system of any one of claims 18-23, wherein light provided by the one or more lights is projected or directed across the room/space.

25. The system of any one of claims 18-24, wherein a siding or face of the housing comprises the one or more lights.

26. The system of any one of claims 18-25, wherein at least one of the one or more lights is provided to project or direct light upwardly towards a ceiling of the room/space within which said system is to be installed.

27. The system of any one of claims 18-26, wherein at least one of the one or more lights is provided on an interior facing side surface of the housing (i.e., an interior room/space facing direction).

28. The system of any one of claims 18-27, wherein an interior facing side surface of the housing is angled such that a top edge of the housing extends horizontally beyond a lower edge of the housing.

29. The system of any one of claims 18-28, wherein the light is provided with a reflector, the light positioned in front of the reflector, optionally a diffuser positioned in front of the light, and optionally such an arrangement of a reflector and light is provided within a housing or within a body of a pelmet-style blind box arrangement.

30. The system of any one of claims 1-29, wherein the system comprises a sensor or sensors for measurement and/or detection of one or more room conditions.

31. The system of claim 30, wherein the one or more room conditions is one or more of: motion or activity within a room/space (for example, occupancy), light level within a room/space (for example, ambient flux levels within the room/space), external ambient light level, combinations of room/space and external light levels, temperature of a room/space, a timer schedule based upon a time-of-day or day of week, a manual signal input from a user, gestures from a user, (such as macro or micro physical gestures from a user), voice or other audible sounds from a user (such as voice or audible sound activation or control or commands, directly or indirectly, via one or more devices capable of measuring or detecting such sounds).

32. The system of any one of claims 1-18, wherein the controller operates to adjust one or more of the following:
the motor to adjust the roller blind or screen to a desired extension position based upon one or more of the room conditions, for example to reduce light levels within a room/space or reduce incoming external light (e.g., sunlight as the light source),
the light output level in response to ambient light conditions (e.g., a light output may be ramped up or ramped down as needed, or to provide for a slow or soft start or slow or soft finish to turning the one or more lights on or off).

33. The system of claim 32, wherein the controller operates to adjust based upon a measured or detected room condition.

34. The system of claim 33, wherein the room condition is measured or sensed by one or more sensors integrated with the system or as part of the housing.

35. The system of claim 33 or 34, wherein the room condition is measured or sensed by one or more sensors provided remotely about a room/space, and providing a signal back to the controller (e.g., the remote sensor or sensors may communicate with the controller via a wired or wireless communication link).

36. The system of any one of claims 1-35, wherein a manual input from a user is a signal sent to/received by a sensor or the controller, to manually provide a desired extension position of the roller blind.

37. The system as claimed in any one of claims 1-36, wherein a user manually sets or adjusts, from a default setting, a preferred light level within a room or temperature of a room or based upon the amount of motion or level or activity within a room over a period of time, or adjusts a pre-determined timer schedule or other automatic adjustment based upon a measured or detected room/space condition.

38. The system as claimed in any one of claims 1-37, wherein a signal from a user for the manual setting or adjustment is to be communicated via a data communication link or network protocol via a wired or wireless communication or network or combination thereof (examples include, but are not limited to: NFC, wi-fi, Bluetooth, LTE, Zigbee communication link or network protocol enabled systems).

39. The system as claimed in any one of claims 1-38, wherein manual adjustment is provided for via a control panel or switching on a housing or other associated controller of the system (for example may have an on/off switch).

40. The system of any one of claims 1-39, wherein the roller blind system is provided as a single unit configured for fastening or fixing into position (for example, the system can be fastened or fixed into a position to cover (partially or substantially wholly) a window or other sunlight light transmitting medium, including but not limited to one or more of: glass, polymers, composite materials).

41. The system of any one of claims 1-40, wherein the system is configured as a single module or a plurality of modules (optionally one or more of which may be directly or indirectly connected or connectable with one or more other modules) which is either factory pre-assembled or assembled on-site.

42. The system of claim 41, wherein the system is provided as a single module without the need for additional on-site assembly or other connections, or is provided as a single completed unit in a ready-to-ship or ready-to-install configuration.

43. The system of any one of claims 1-42, wherein the system is independent or independently operable of or from a building's power or electrical supply, optionally the system is connected, or is connectable, to a building's power or electrical supply as a back-up power supply.

44. The system of any one of claims 1-43, wherein the system communicates with or be provided in communication with, a building management system (BMS).

45. The system as claimed in claim 44, wherein the system is operable or controllable via a BMS.

46. The system of any one of claims 1-45, wherein in an in-use or installed configuration, the blind is wound in a configuration such a portion of photovoltaic film remains exposed.

47. The system of any one of claims 1-46, wherein a portion of the photovoltaic film remains exposed to, in-use, face towards an external face of a building envelope, even when in a fully or completely retracted blind position, or in a fully wound up or rolled up position.

48. The system of any one of claims 1-47, wherein in-use, a pre-determined length portion of said roller blind including the photovoltaic film, is left exposed (for example, for generation of photovoltaic energy and/or capture by said energy storage system).

49. The system of any one of claims 1-48, wherein in-use, a pre-determined length portion of said roller blind including the photovoltaic film, is left advanced from a fully or completely retracted position (for example, for generation of photovoltaic energy and/or capture by said energy storage system).

50. The system of any one of claims 1-49, wherein said system is pre-programmed to, upon initial set up, wind said roller blind or screen to a pre-determined extension length or position (for example, to an advanced or retracted position).

51. The system of any one of claims 1-50, wherein an in-use maximum retracted position of the blind provided for a pre-determined minimum extension length substantially sufficient to enable a minimum power generation or charge of power for use by the system (for example or to be retained by the energy storage system).

52. The system of any one of claims 1-51, wherein a portion of the blind, once installed or when in an in-use configuration, or in a fully wound up or rolled up position, remains exposed to provide for a trickle charge capability.

53. The system of any one of claims 1-52, wherein a minimum exposed surface area of the photovoltaic film left exposed is self-adjusting based upon a minimum required trickle charge or minimum stored power requirement of the energy storage system.

54. The system of any one of claims 1-53, wherein the energy storage system is a battery or other electrical energy storage device.

55. The system of any one of claims 1-54, wherein data relating to one or more sensed room conditions is provided to a building management system (BMS) or other control system.

56. The system of any one of claims 1-55, wherein a plurality of systems is provided and two or more of these substantially operate as to a retracted or advanced blind length or position (or length of extension) or to substantially match a blind position.

57. The system of any one of claims 1-56, wherein the photovoltaic film provides cover or coverage of substantially all or substantially a partial surface area of the blind (for example, to enable some light to pass the blind).

58. The system of any one of claims 1-57, wherein the photovoltaic film is provided as a pattern across the blind (for example, as a series of stripes, whether at an angle or substantially vertical or substantially horizontal when made with reference to the up/down directionality of the blind moving between retracted and advanced blind positions).

59. The system of any one of claims 1-58, wherein at least a bottom or lower portion, also referred to as a tail or foot, of the blind comprises of the photovoltaic film (for example, when the blind is being unwound or advanced from a retracted position, at least a first portion of the blind advanced from a fully or completely retracted blind position, or in a fully wound up or rolled up position, may comprise of the photovoltaic film, and a portion of the blind, for example a portion of the blind which may, in-use, more often remain substantially in a wound up or unused or retracted position may be devoid of the photovoltaic film).

60. A roller blind system comprising:
a roller blind, the roller blind comprising of a photovoltaic film configured to, in-use, face towards an external face of a building envelope,
an energy storage system receivable of power generated from the photovoltaic film,
a motor connectable via a drive system for winding of the roller blind, the roller blind to be wound to an advanced or retracted position,
a controller configured to operate at least the motor for windingly advancing or retracting the roller blind to a desired extension position,
wherein in-use, a pre-determined length portion of said roller blind comprising of the photovoltaic film is left exposed.

61. The system of claim 60, wherein the pre-determined length portion of said roller blind comprising of the photovoltaic film left exposed is a minimum surface area of photovoltaic film substantially sufficient for a minimum operation of the system (or for example for at least a minimum generation of photovoltaic energy and capture by or charging of the energy storage system).

62. The system of claim 60 or 61, further comprising any one or more of the systems as defined by any one or more of claims 1-59.

63. A roller blind system comprising:
a roller blind, the roller blind comprising of a photovoltaic film configured to, in-use, face towards an external face of a building envelope,
an energy storage system receivable of power generated from the photovoltaic film,
a motor connectable via a drive system for winding of the roller blind, the roller blind to be wound to an advanced or retracted position,
a controller configured to operate at least the motor for windingly advancing or retracting the roller blind to a desired extension position, and
one or more lights to be powered by the energy storage system.

64. The system of claim 63, further comprising any one or more of the systems as defined by any one or more of claims 1-62.

65. A system comprising one or more roller blind system as defined in any one of claims 1-64, wherein the one or more roller blind systems as defined are electrically connectable to a motorised blind system or to one or more roller blind systems as defined.

66. The system of claim 65, wherein a roller blind system as defined in any one of claims 1-64 provides electrical power for another (electrically connected) motorised roller blind.

67. A roller blind system, the roller blind system comprising:
at least one first roller blind, and at least one second roller blind, to be installed in a substantially parallel configuration and arranged in a manner such that when in-use, the first roller blind is to be positioned relatively more outwardly, or toward a light source, than the second roller blind, and the second roller blind is to be positioned relatively more inwardly, or further away from the light source, then the first roller blind,
wherein at least one of the first roller blind(s) or the second roller blind(s), or both of the first roller blind(s) and the second roller blind(s), comprises of a photovoltaic film configured to, in-use, face towards a light source (such as an external face of a building envelope),
and wherein each first roller blind(s) and the second roller blind(s) are independently operable,
an energy storage system receivable of power generated from the photovoltaic film,
a motor connectable via a drive system for winding of each of the first roller blind(s) and/or the second roller blind(s), each of the first and/or second roller blinds to be wound to an advanced or retracted position, and
a controller configured to operate at least the motor for windingly advancing or retracting each of the first and/or second roller blind(s) to a desired extension position.

68. The system as claimed in claim 67, wherein in-use, a pre-determined length portion of at least one of the roller blind(s) comprising of the photovoltaic film is left exposed, for exposure to a light source.

69. The system as claimed in claim 67 or 68, wherein the roller blind system further comprises of a housing as a blind box or a pelmet-style covering (or enclosure) of the system.

70. The system as claimed in any one of claims 67-69, wherein the roller blind system is a dual (two) blind configuration.

71. The system as claimed in any one of claims 67-70, wherein the first roller blind(s) comprises of the photovoltaic film, or a portion of the first roller blind comprises of photovoltaic film.

72. The system as claimed in any one of claims 67-71, wherein the second roller blind(s) comprises of the photovoltaic film, or a portion of the second roller blind comprises of photovoltaic film, or the second roller blind is entirely devoid of photovoltaic film.

73. The system as claimed in any one of claims 67-72, wherein the photovoltaic film of the first roller blind or the second roller blind, or the photovoltaic film of the portion of the first roller blind or of the portion of the second roller blind, is substantially a tail or foot portion of the first roller blind and/or the second roller blind, and the photovoltaic film optionally extends substantially across the width of the roller blind, either partially or substantially wholly, across the width, or alternatively, or in addition, the photovoltaic film optionally extends substantially along the length of the roller blind, either partially or substantially wholly, along the length.

74. The system as claimed in any one of claims 67-73, wherein the second roller blind is substantially a shade style roller blind.

75. The system as claimed in any one of claims 67-74, wherein the second roller blind is substantially devoid of photovoltaic film.

76. The system as claimed in any one of claims 67-75, wherein a portion or portions (such as segmented portions or sections which may optionally be separated from each other) of the second roller blind comprise of the photovoltaic film, or optionally, where a portion or portions of the extension length of the second roller blind comprises of photovoltaic film, the remainder of the extension length of the second roller blind is devoid of photovoltaic film and optionally is of a shade style blind material.

77. The system as claimed in any one of claims 67-76, wherein the portion of the second roller blind comprising of the photovoltaic film is a tail or foot of the second roller blind.

78. The system as claimed in an one of claims 67-77, wherein the portion of the second roller blind comprising of the photovoltaic film is about 95% or less of the extension length of the first roller blind, or is about 90% or less, or is about 80% or less, or is about 75% or less, or is about 70% or less, or is about 60% or less, or is about 50% or less, or is about 40% or less, or is about 30% or less, or is about 25% or less, or is about 20% or less, or is about 15% or less, or is about 10% or less, or is about 5% or less of the extension length of the first roller blind.

79. The system as claimed in any one of claims 67-78, wherein the first roller blind comprises of the photovoltaic film.

80. The system as claimed in any one of claims 67-79, wherein a portion or portions (such as segmented portions or sections which are optionally separated from each other) of the first roller blind comprises of the photovoltaic film.

81. The system as claimed in any one of claims 67-80, wherein the portion of the first roller blind comprising of the photovoltaic film is about 100% or less of the extension length of the second roller blind, or is about 95% or less, or is about 90% or less, or is about 80% or less, or is about 75% or less, or is about 70% or less, or is about 60% or less, or is about 50% or less, or is about 40% or less, or is about 30% or less, or is about 25% or less, or is about 20% or less, or is about 15% or less, or is about 10% or less, or is about 5% or less of the extension length of the first roller blind.

82. The system as claimed in any one of claims 67-81, wherein of an extension length of the second roller blind, the second roller blind comprises at least one portion of which comprises of the photovoltaic film and at least one other portion of which is of a shade style material (for example, optionally is devoid of the photovoltaic film), and wherein of an extension length of the first roller blind, the extension length of the first roller blind is substantially comprised of the photovoltaic film.

83. The system as claimed in any one of claims 67-82, wherein the second roller blind comprises of a portion of which comprises the photovoltaic film and the remainder of the extension length comprises of a shade style material (being optionally devoid of photovoltaic film), and the first roller blind is substantially comprised of photovoltaic film.

84. The system as claimed in any one of claims 67-83, wherein the first roller blind is configured as defined in any one of claims 1-66.

85. The system as claimed in any one of claims 67-83, wherein the second roller blind is configured as defined in any one of claims 1-66.

86. The system as claimed in any one of claims 67-85, wherein the first roller blind and the second roller blind are configured in a single housing or enclosure as defined in any one of claims 1-66.

87. The system as claimed in any one of claims 1-86, wherein where a photovoltaic film is provided as part of a roller blind, the photovoltaic film comprises of a front or face side which initially receives light or energy from a light or energy source, and back or rear side which comprises of a reflector for reflecting of received energy (such as from a light or energy source).
